(19) United States
(12) Patent Application Publication
(10) Pub. No.: US 2013/0097159 A1
(43) Pub. Date: Apr. 18, 2013

(54) SYSTEM AND METHOD FOR PROVIDING INFORMATION REGARDING CONTENT

(71) Applicant: Samsung Electronics Co., Ltd., Gyeonggi-do (KR)

(72) Inventors: Donghun PARK, Gyeonggi-do (KR); Wonho RYU, Gyeonggi-do (KR); Taehyun YOON, Gyeonggi-do (KR); Ilhwan CHOI, Gyeonggi-do (KR)

(73) Assignee: Samsung Electronics Co., Ltd., Gyeonggi-do (KR)

(21) Appl. No.: 13/651,962

(22) Filed: Oct. 15, 2012

(30) Foreign Application Priority Data
Oct. 13, 2011 (KR) 10-2011-0104526

(51) Int. Cl. G06F 17/30

(52) U.S. Cl. 707/723; 707/E17.082

(57) ABSTRACT

A system and method is provided that collects and analyzes social media data and provides information regarding content that are popular to users or attract attention. The method includes creating a keyword related to the content;

collecting social media data including the created keyword; analyzing the collected social media data, and extracting content-related information; associating social media data with the extracted content-related information; storing the content-related information; and providing the stored content-related information.

### PRIORITY

This application claims priority under 35 U.S.C. §119(a) to a Korean patent application filed on Oct. 13, 2011 in the Korean Intellectual Property Office and assigned Serial No. 10-2011-0104526, the entire disclosure of which is incorporated herein by reference.

### BACKGROUND OF THE INVENTION

1. Field of the Invention

This invention relates generally to a system and method that collects and analyzes social media data and provides information regarding content that is popular or attracts users' attention.

2. Description of the Related Art

Digital broadcasting technology has been developed to provide services in a bidirectional or interactive mode, and also to broadcast additional information as well as broadcasting information, unlike conventional analog broadcasting technology. Digital broadcasting systems broadcast video and audio, created in broadcasting stations, and content created by content providers, and the corresponding Set Top Boxes (STBs) receive the broadcasts and reproduce the video and content via digital TeleVisions (TVs). For example, digital broadcasting systems can broadcast content, e.g., information regarding broadcasts, weather, stocks, news, etc., as well as broadcasts. Digital broadcasting systems also provide Internet services and electronic commerce (e-commerce) services.

Conventional digital broadcasting systems broadcast broadcasting signals with information regarding broadcasts. Users view information regarding broadcasts provided by broadcasting service providers. Since the information regarding broadcasts that is broadcasted together with broadcasting information depends on broadcasting service providers, conventional digital broadcasting systems are problematic in that they do not precisely reflect recent trends in the broadcasts and do not include user-oriented information regarding broadcasts. Moreover, conventional digital broadcasting systems extract keywords from titles of broadcasts, actors, subtitles, etc., search for portal websites based on the keywords, and provide information regarding broadcasts based on the search result. However, since conventional broadcasting systems depend on the web search results, they cannot provide information regarding broadcasts that are recently popular.

### SUMMARY OF THE INVENTION

The present invention has been made in view of the above problems, and provides a system and method that analyzes social media data registered in a social media server, collects and analyzes information regarding content issued to users, and provides it to the users.

In accordance with an embodiment of the present invention, a method for providing content-related information is provided. The method includes creating a keyword related to the content; collecting social media data including the created keyword; analyzing the collected social media data, and extracting content-related information; associating social media data with the extracted content-related information; storing the content-related information; and providing the stored content-related information.

In accordance with another embodiment of the present invention, a system for providing content-related information is provided. The system includes a content-related information-providing server for providing content-related information; a social media service server for providing a social media service and storing social media data; a mining server for creating a keyword related to the content, collecting and analyzing social media data including the keyword transmitted from the social media service server, extracting and storing information regarding the content, and providing the stored content-related information; and a media playback device for receiving the content-related information from the mining server and displaying it.

In accordance with another embodiment of the present invention, a method for providing content-related information is provided. The method includes acquiring, by a media playback device, items of content and content-related information in a content-related information-providing mode; configuring a content item including a content display area for identifying the content and a first content-related information display area for providing the content-related information, based on the acquired content and the content-related information; and displaying a content list of content items.

### BRIEF DESCRIPTION OF THE DRAWINGS

The aspects, features and advantages of the present invention will become more apparent from the following detailed description viewed in conjunction with the accompanying drawings, in which:

FIG. 1 illustrates a schematic block diagram of a system for providing content-related information according to an embodiment of the present invention;

FIG. 2 illustrates a schematic block diagram of a mining server in the system shown in FIG. 1;

FIG. 3 illustrates a flowchart that describes a method for collecting social media data, according to an embodiment of the present invention;

FIG. 4 illustrates social media data, collected via the method of FIG. 3, according to an embodiment of the present invention;

FIG. 5 illustrates a flowchart that describes a method for analyzing collected social media data, according to an embodiment of the present invention;

FIG. 6 illustrates content-related information, extracted via the method of

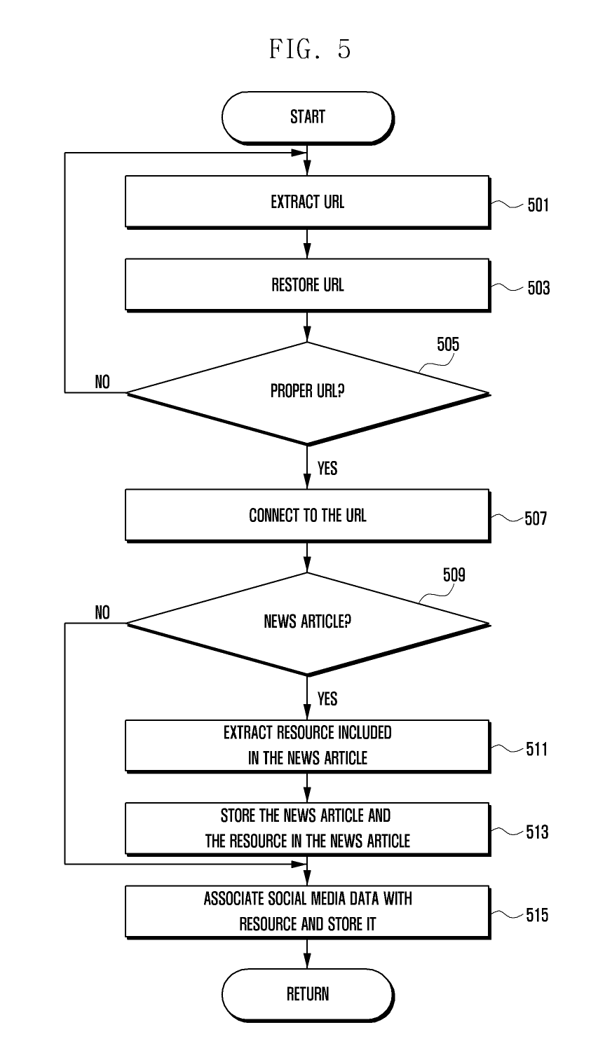

FIG. 5, according to an embodiment of the present invention;

FIG. 7 illustrates a flowchart that describes a method for providing content-related information, according to an embodiment of the present invention; and

FIGS. 8 to 10 illustrate screens on which interfaces providing content-related information are shown.

### DETAILED DESCRIPTION OF EMBODIMENTS OF THE PRESENT INVENTION

Hereinafter, embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the invention.

The system and method according to the present invention create keywords related to content, collect and analyze social media data included in the keywords, collect content-related information described in the social media data, and provide it to users. Examples of the content include broadcasts, electronic books (e-books), movies, music, plays, musicals, games, and the like. Examples of social media data may be text that users registered via social media services such as Twitter®, Facebook®, and the like. Content-related information refers to Internet news articles, images, movie trailers, etc., and is extracted based on the link information included in the collected social media data.

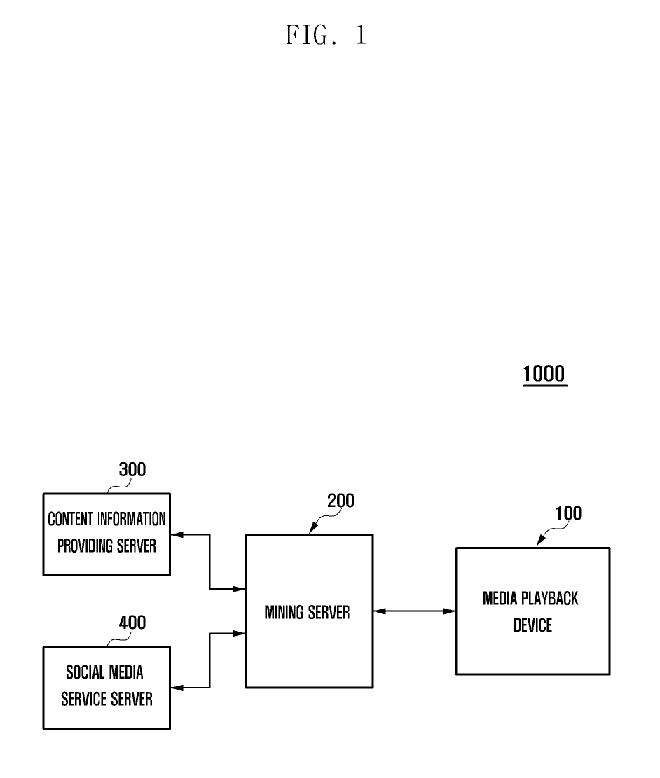

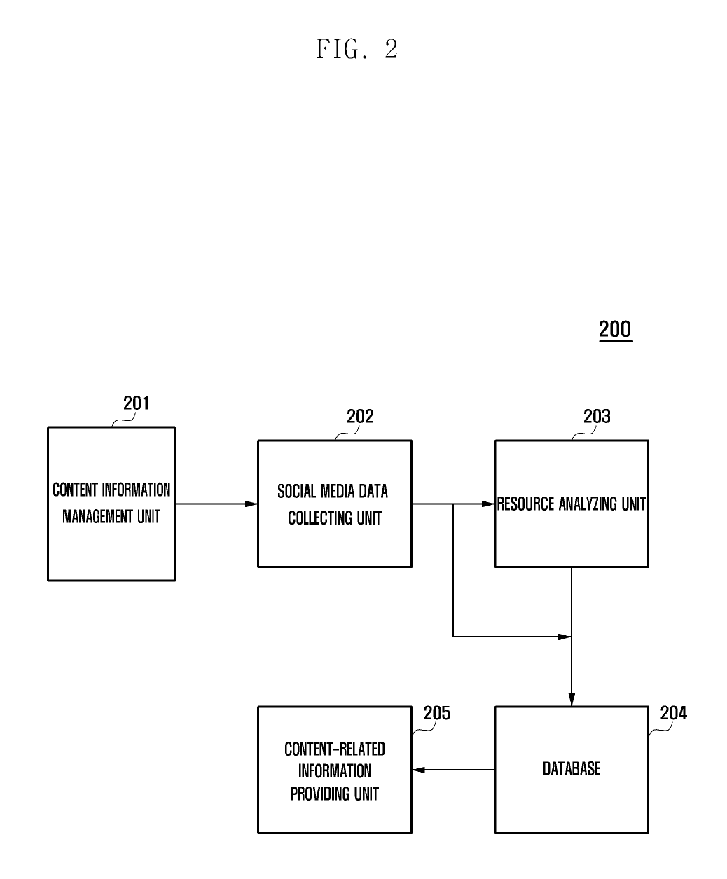

FIG. 1 illustrates a schematic block diagram of a system for providing content-related information according to an embodiment of the present invention. FIG. 2 illustrates a schematic block diagram of a mining server in the system shown in FIG. 1.

Referring to FIGS. 1 and 2, the system 1000 includes a media playback device 100, a mining server 200, a content information-providing server 300, and a social media service server 400.

The content information-providing server 300 provides content information to the mining server 200. The content information-providing server 300 is a portal website server. Examples of the content include broadcasts, movies, e-books, music, plays, musicals, etc. Information regarding content is the content title, channel information, rank information, singers' names, directors' names, actors' names, etc. The information regarding content is used as keywords.

The social media service server 400 provides social media services such as Twitter®, Facebook®, etc. The social media service server 400 stores social media data that users registered. A Social Media Service is also called a social network service. The invention will be described using the term Social Media Service.

The mining server 200 collects, analyzes, and stores content-related information, and provides it to the media playback device 100 according to the user's request. To this end, as shown in FIG. 2, the mining server 200 includes a content information management unit 201, a social media data-collecting unit 202, a resource-analyzing unit 203, a database 204, and a content-related information-providing unit 205.

The content information management unit 201 creates keywords for collecting social media data. Examples of the keywords are broadcast titles, movie titles, book titles, etc. To this end, the content information management unit 201 uses rank information provided by the content information-providing server 300, for example, a portal website. The content information management unit 201 updates keywords. For example, the content information management unit 201 adds keywords for new content and removes keywords regarding content that is used. The content information management unit 201 processes the created keywords. For example, if a broadcast title is acquired as a keyword, the content information management unit 201 processes a keyword in such a way that channel information, a broadcasting station's name, and/or a leading actor's name, etc., are added to the broadcast title.

The social media data-collecting unit 202 receives at least one keyword from the content information management unit 201. The social media data-collecting unit 202 accesses the social media service server 400, and collects social media data with keywords therefrom. For example, the social media data-collecting unit 202 collects texts including the keywords from the texts that are registered in the social media service server 400, via Twitter®, Facebook®, etc. The social media data-collecting unit 202 filters social media data, such as advertisements and adult content, from the collected social media data. For example, the social media data-collecting unit 202 filters and removes social media data that does not have link information, or includes preset phrases (e.g., adult content-related phrases, spam phrases, etc.). It should be understood that the invention employs a variety of spam content blocking methods.

The resource-analyzing unit 203 analyzes the collected social media data, and extracts and stores the content-related information. The resource-analyzing unit 203 accesses a link included in the social media data, e.g., a Uniform Resource Locator (URL), extracts resources (e.g., texts, images, videos, etc.) from the content providing server 300, and stores the content-related information in the database 204. If a URL is a shortened URL, the resource-analyzing unit 203 may restore the URL. The resource-analyzing unit 203 detects whether the linked URL is a previously analyzed URL. If the resource-analyzing unit 203 determined that the linked URL is a previously analyzed URL, it does not extract resources of the URL. Alternatively, if the resource-analyzing unit 203 determined that the URL is a spam-related URL, it does not extract resources of the URL and removes the social media data.

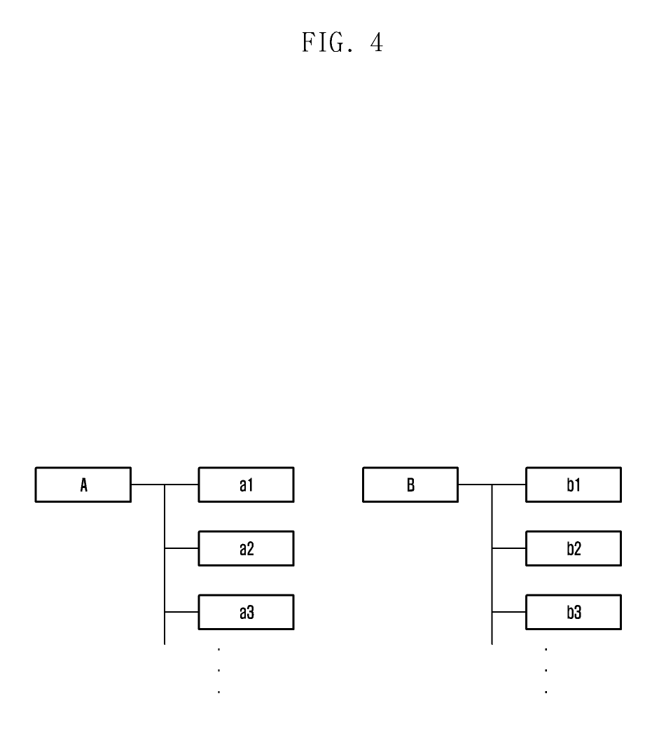

The database 204 stores social media data, collected via the social media data-collecting unit 202, and content-related information extracted via the resource-analyzing unit 203, further associated with social media data. The database 204 also stores sources of the content-related information, i.e., link information, associated with the social media data. This will be described in detail later referring to FIGS. 4 to 6.

The content-related information-providing unit 205 is wirelessly or wiredly connected to the media playback device 100. The content-related information-providing unit 205 transfers content-related information from the database 204 to the media playback device 100, according to the request signal from the media playback device 100. For example, the content-related information-providing unit 205 transfers a list of content that has been issued to the media playback device 100. If the media playback device 100 selects a particular content, the content-related information-providing unit 205 transfers a list of information related to the selected content to the media playback device 100. If the information regarding a particular content is selected, the content-related information-providing unit 205 then transfers the detailed information regarding the content and the social media data associated with the detailed information to the media playback device 100.

The media playback device 100 refers to an electronic device with a display. The media playback device 100 receives content-related information from the mining server 200 and displays it. The media playback device 100 displays a content list of one or more content items. If a particular content item is selected from the content list, the media playback device 100 displays a content-related information list of one or more pieces of content-related information related to the selected content item. If a particular piece of content-related information is selected, the media playback device 100 displays detailed information regarding the selected content-related information. The media playback device 100 is a digital TV, an Internet Protocol TV (IPTV), a desktop computer, a laptop computer, a tablet PC, a smart phone, etc. The media playback device 100 will be described in detail later referring to FIGS. 7 to 10.

As described above, the system and method according to the present invention extracts keywords for searching for content, using search rank information, etc., in portal websites, collects social media data including the keyword, and collects content-related information using link information included in the social media data. That is, the system and method according to the invention collects information regarding content that is issued to users from social media data and provides it to the users, compared with conventional systems where content-related information is provided via a portal website search function. Therefore, the system and method according to the invention can provide information regarding user-oriented content to users, thereby satisfying the users with their search results.

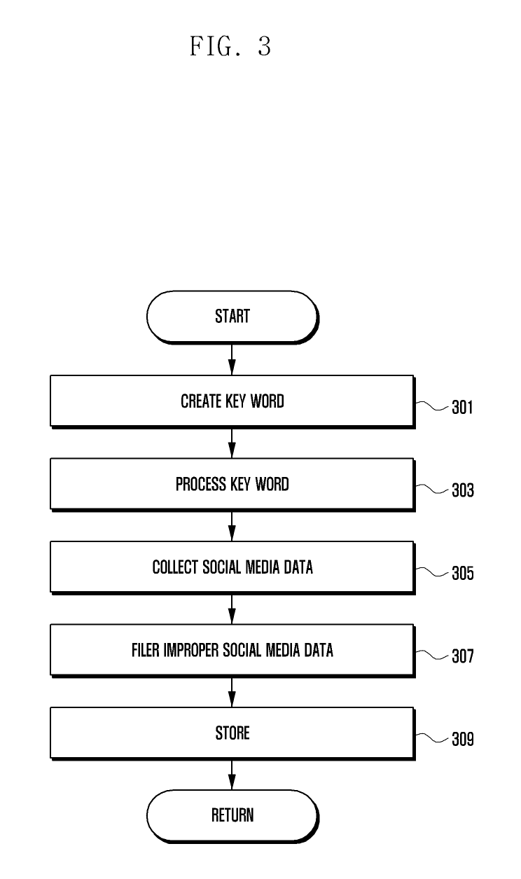

FIG. 3 illustrates a flowchart that describes a method for collecting social media data, according to an embodiment of the present invention. FIG. 4 illustrates social media data, collected via the method of FIG. 3, according to an embodiment of the present invention.

Referring to FIGS. 1 to 4, the content information management unit 201 creates a list of keywords in step 301. An example of the keywords is a title of content such as broadcasts, e-books, movies, etc. Keywords are added to or removed from the list. For example, if a new broadcast program is televised or a new movie is shown, the title of the broadcast program or the movie is added to the keyword list. However, if the season of televising a broadcast program is terminated or a period of time for showing a movie has elapsed, the title of the broadcast program or the movie is removed from the keyword list. To this end, the mining server 200 accesses the content information-providing server 300, e.g., a portal website, etc., and collects information (e.g., titles) regarding content that has been recently issued.

The content information management unit 201 processes the collected keywords in step 303. That is, if a title of content, used as a keyword, is a word that has been usually used, the process of the collected keywords is a process for adding additional information in order to correctly search for corresponding content. For example, if a title of a broadcast program is “a bunch of flowers,” the content information management unit 201 processes a keyword by adding additional information such as the channel number televising the broadcast program, the name of leading actor, the producer, etc.

The social media data-collecting unit 202 collects social media data using the keyword list in step 305. To this end, the social media data-collecting unit 202 accesses the social media service server 400 and collects social media data including the keyword. The social media service server 400 provides social media services such as Twitter®, Facebook®, etc. Examples of the social media data is text including the keyword that users registered in the social media service server 400. The social media data-collecting unit 202 uses an Application Programming Interface (API) provided via social media services in order to collect social media data.

The social media data-collecting unit 202 filters improper social media data from the collected social media data in step 307. For example, the social media data-collecting unit 202 filters spam-like social media data such as advertisements, adult-related content, etc. To this end, the social media data-collecting unit 202 employs a variety of spam blocking technologies for filtering improper social media data.

The social media data-collecting unit 202 stores the filtered social media data in the database 204 in step 309. As shown in FIG. 4, the database 204 stores the content associated with the filtered social media data. Referring to FIG. 4, content A is associated with social media data a1, social media data a2, social media data a3, etc.; and content B is associated with social media data b1, social media data b2, social media data b3, etc. The mining server 200 then updates the information stored in the database 204 by repeating the steps described above.

After collecting the social media data, the mining server 200 detects the frequency of referring to the keywords with respect to the social media data. The mining server 200 sets content corresponding to a keyword with a high frequency of reference to popular content, and content corresponding to a keyword with a low frequency of reference to unpopular content. The social media data-collecting unit 202 does not collect social media data corresponding to unpopular content for a preset period of time.

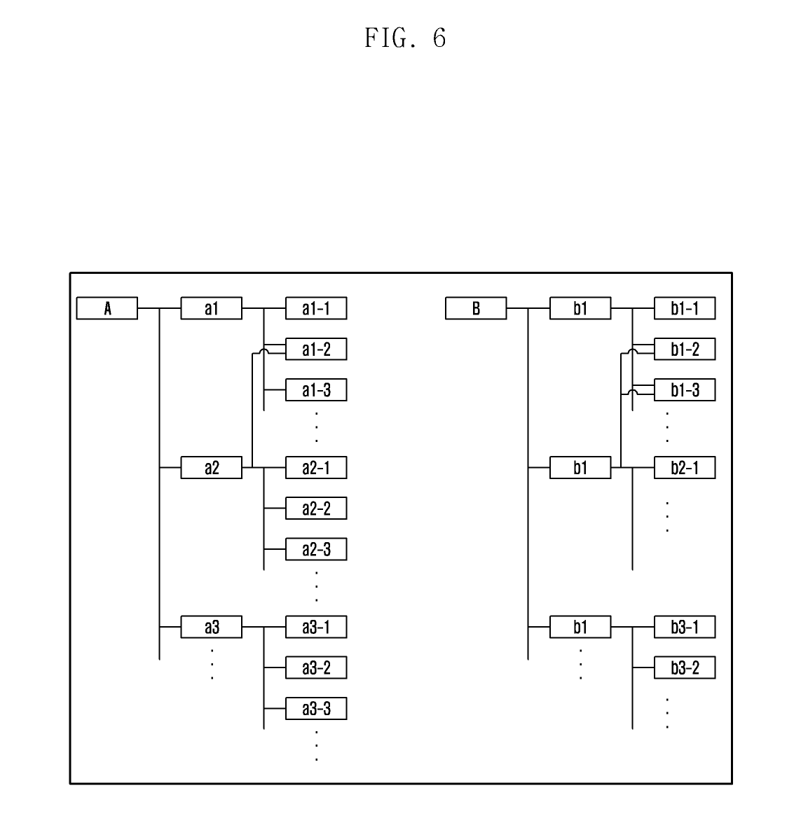

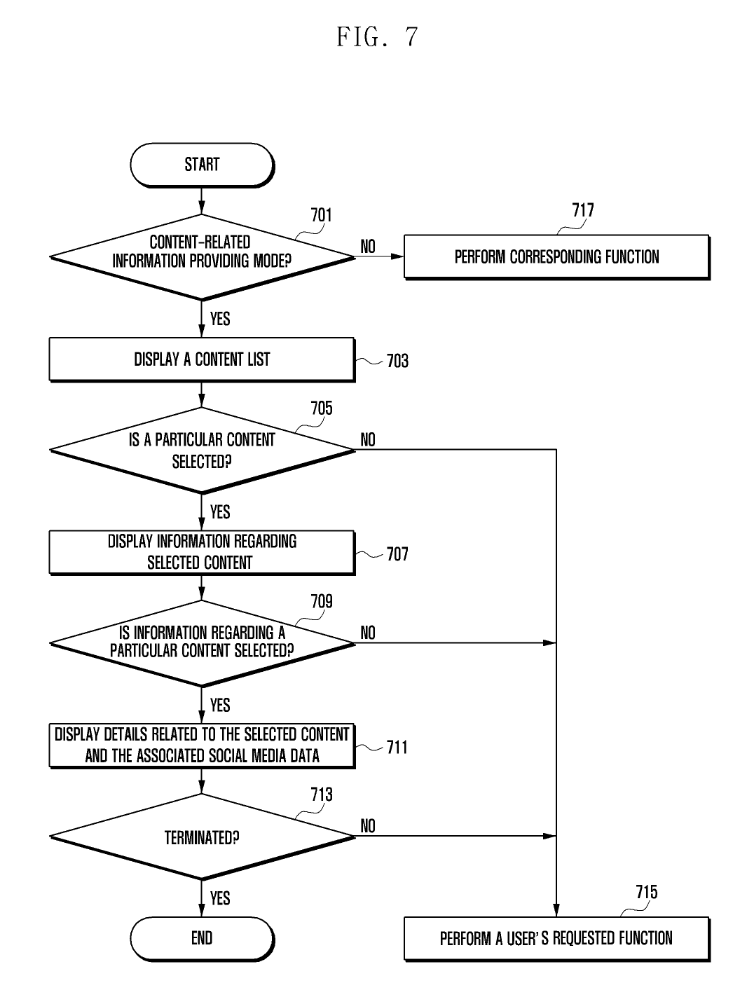

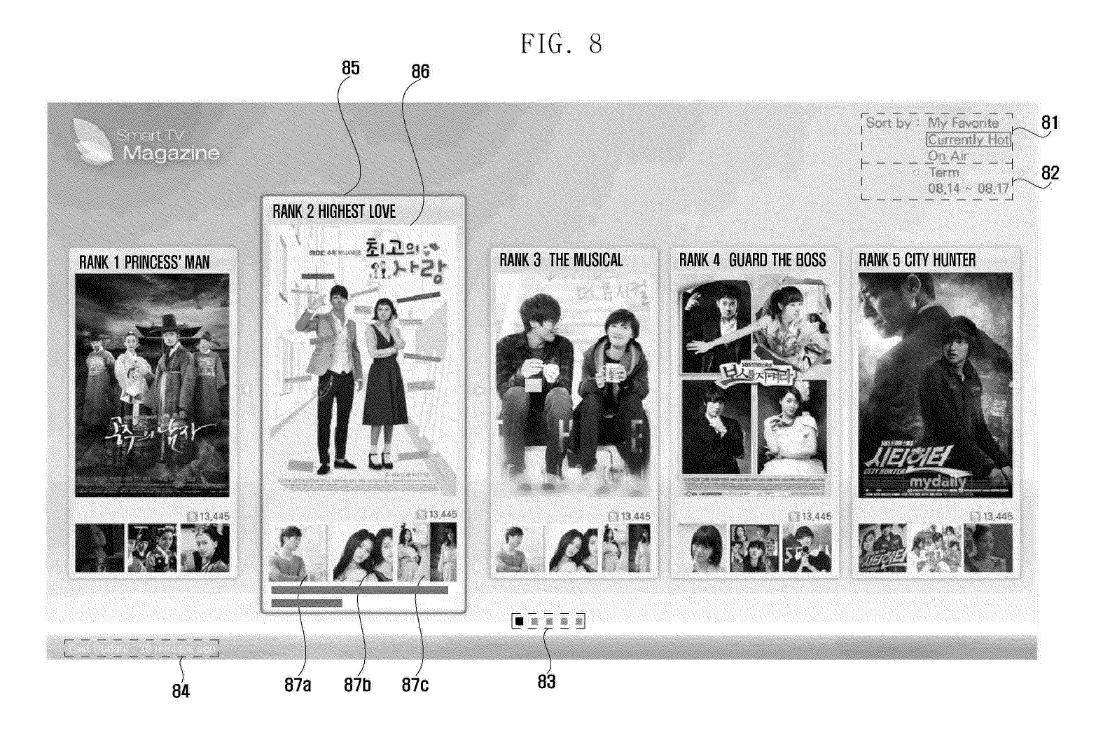

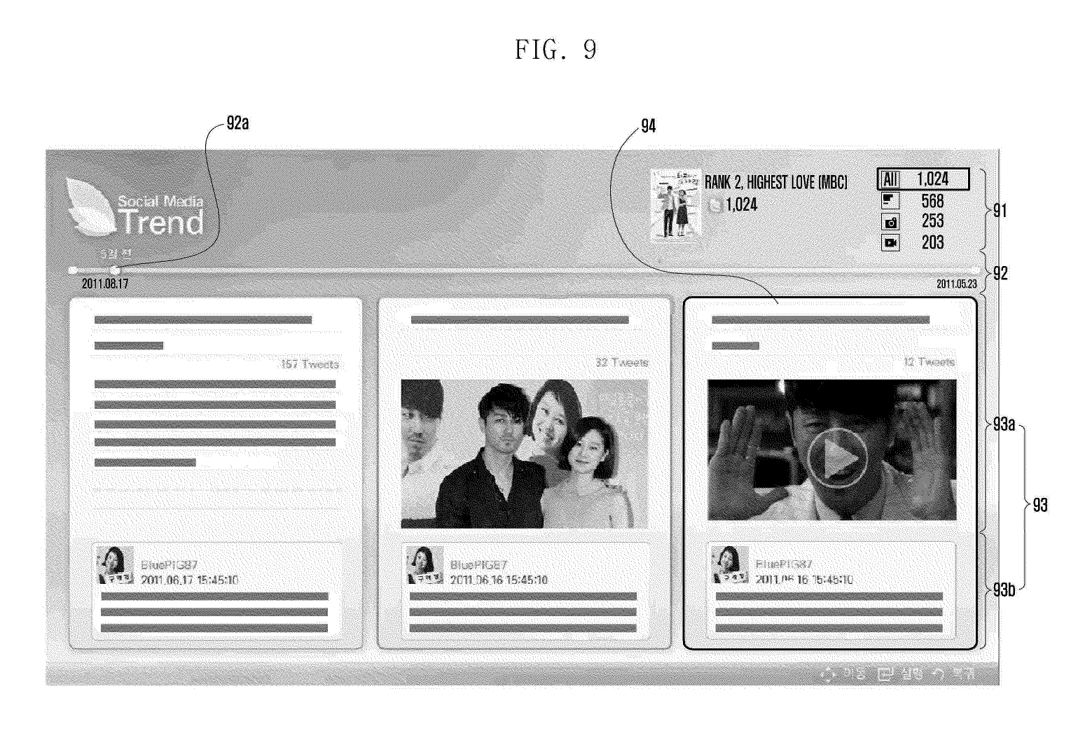

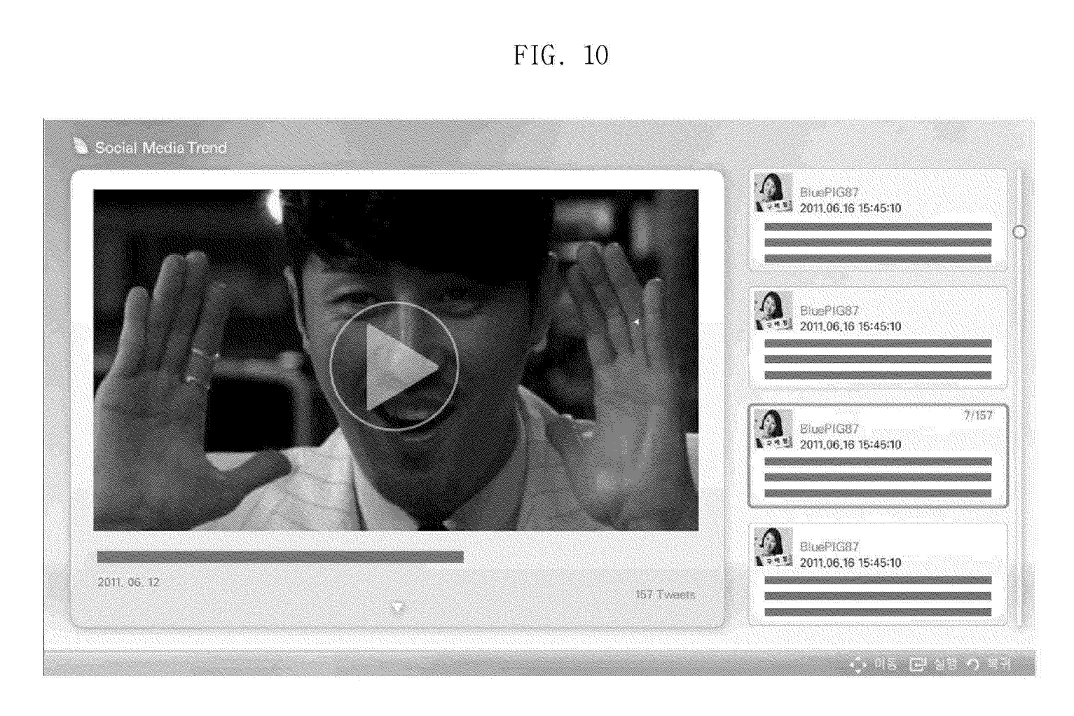

FIG. 5 illustrates a flowchart that describes a method for analyzing collected social media data, according to an embodiment of the present invention. FIG. 6 illustrates content-related information, extracted via the method of FIG. 5, according to an embodiment of the present invention.

Referring to FIGS. 1 to 6, the resource-analyzing unit 203 extracts a URL from the social media data, collected via the method described above referring to FIG. 3, in step 501, and restores the URL in step 503. In an embodiment of the present invention, if the URL extracted in step 501 is not a shortened URL, the method is implemented without step 503.

The resource-analyzing unit 203 determines whether the restored URL is a proper URL, or a previously analyzed URL in step 505. If the resource-analyzing unit 203 determines that the restored URL is not a previously analyzed URL in step 505, it concludes that the restored URL is a proper URL. However, if the resource-analyzing unit 203 determines that the restored URL is a previously analyzed URL in step 505, it concludes that the restored URL is not a proper URL. This is because, although social media data differ from one another, they may have the same URL information. The resource-analyzing unit 203 associates the social media data with information regarding the previously analyzed content. Alternatively, the resource-analyzing unit 203 determines whether the restored URL is a spam URL. If the resource-analyzing unit 203 determines that the restored URL is not a spam URL, it concludes that the restored URL is a proper URL. However, if the resource-analyzing unit 203 determines that the restored URL is a spam URL, it concludes that the restored URL is not a proper URL. In that case, the resource-analyzing unit 203 removes the social media data with the corresponding URL.

If the resource-analyzing unit 203 determines that the restored URL is not a proper URL in step 505, it returns to and proceeds with step 501. However, if the resource-analyzing unit 203 determines that the restored URL is a proper URL in step 505, it accesses a corresponding URL in step 507. The resource-analyzing unit 203 then determines whether the content linked to the URL is a news article in step 509. If the resource-analyzing unit 203 determines that the content linked to the URL is a news article (e.g., a webpage) in step 509, it extracts resources (texts, images, videos, etc.) from the news article in step 511. For example, if the news article includes videos or images, the resource-analyzing unit 203 extracts the videos or images from the news article. The resource-analyzing unit 203 then associates the extracted resources with the news article and stores them in the database 204 in step 513.

The resource-analyzing unit 203 associates the extracted resources with social media data and stores them in the database 204 in step 515. The resource-analyzing unit 203 integrates the same resource as one resource and stores it. Referring to FIG. 6, resource a1-1, resource a1-2 and resource a1-3 are associated with social media data a1. Likewise, resource a1-2, resource a2-1, resource a2-2 and resource a2-3 are associated with social media data a2. That is, social media data a1 and social media data a2 commonly include resource a1-2. After storing the data and resources, the resource-analyzing unit 203 returns to and proceeds to step 501.

However, if the resource-analyzing unit 203 determines that the content linked to the URL is not a news article, or video content or image content is directly linked to the URL, in step 509, the resource-analyzing unit 203 proceeds to step 515.

FIG. 7 illustrates a flowchart that describes a method for providing content-related information, according to an embodiment of the present invention. FIGS. 8 to 10 illustrate screens on which interfaces providing content-related information are shown.

Referring to FIGS. 1 to 10, the media playback device 100 determines whether an application, e.g., a widget, is operated to execute a content-related information-providing mode in step 701.

If the media playback device 100 determines that an application is operated to execute a function that does not correspond to a content-related information-providing mode, in step 701, it executes the function in step 717. Examples of the function include an audio playback function, a broadcast receiving function, a video playback function, etc. However, if the media playback device 100 determines that an application is operated to execute a content-related information-providing mode in step 701, it displays a list of content items in step 703. Examples of the content items, as shown in FIG. 8, include an image 86 representing the corresponding content, the sub-images 87a, 87b, and 87c corresponding to information regarding the content. The media playback device 100 displays a list of content items according to the frequency of reference to social media data or the number of resources related to social media data. For example, the media playback device 100 displays a list of content items in such a way to arrange the content items, in order, starting from the high frequency of reference to social media data or the large number of resources related to social media data. Alternatively, the media playback device 100 displays content-related information related to content items based on the order of updating the information. To this end, the media playback device 100 requests a list of content items from the mining server 200, by transmitting information regarding a period of time, the sorting reference, etc. to the mining server 200. The media playback device 100 and the mining server 200 perform data communication in Java Script Object Notation (JSON).

Referring to FIG. 8, the content list screen shows a content sorting reference in an area 81 and a period of time collecting content-related information in an area 82. The content list, shown in FIG. 8, includes content that is currently issued, and is arranged according to the result of analyzing social media data registered between the 14^{th} and 17^{th} of August. The user can set the content sorting reference and the period of time collecting content-related information by applying touch gestures to the touchscreen or operating an external control device (e.g., a remote controller).

The region 83 indicates that the content list has additional content items and the first page is currently being displayed. The region 84 indicates that the database has been updated 30 minutes ago. The media playback device 100 displays content items, distinguishing between a user's selected content item and other items. For example, as shown in FIG. 8, the media playback device 100 displays a user's selected content item 85 in a large format than the other content items. That is, distinguishing between a user's selected content item and the others is implemented with a variety of modes, e.g., a mode according to whether a selected content item is highlighted, or a mode for reducing the brightness of non-selected content items by a certain level.

The media playback device 100 displays a list of content items, via a content display area for displaying the content related to a corresponding content item, distinguishing from other content, and a first content-related information display area for providing information related to the corresponding content. To this end, the media playback device 100 acquires content and information related to the content from the mining server 200 in the content-related information-providing mode; configures a content item including a content display area for identifying content and a first content-related information displaying area for providing the content-related information, based on the acquired content and the content-related information; and displays a content list of one or more content items. The content display area provides a representative image 86 of the corresponding content. The first content-related information displaying area provides sub-images 87a, 87b, and 87c corresponding to at least one piece of information related to the corresponding content. That is, the media playback device 100 displays a content list, together with content and partial pieces of information related to the content. For example, as shown in FIG. 8, the media playback device 100 displays a representative image 86 corresponding to the content and a content item 85 below the representative image 86, where the content item 85 includes three sub-images 87a, 87b, and 87c corresponding to pieces of information regarding the content.

The media playback device 100 determines whether a particular content item in the content list is selected in step 705. If the media playback device 100 determines that a particular content item in the content list is not selected in step 705, it performs a user's requested function in step 715. For example, the media playback device 100 switches the current screen to a screen for displaying a content list of content items from ranks 6 to 10. Alternatively, if the sorting reference is altered, the media playback device 100 requests a content list of content items according to the altered sorting reference from the mining server 200 and displays the received content list. If a period of time is altered, the media playback device 100 transmits the information regarding the altered period of time to the mining server 200, receives the content list according to the altered period of time therefrom, and displays it.

However, if the media playback device 100 determines that a particular content item in the content list is selected in step 705, it requests information regarding content associated with the selected content item from the mining server 200 and displays the content-related information list on the screen in step 707. For example, the media playback device 100 displays the content-related information list screen as shown in FIG. 9.

The content-related information list screen includes an area 91 for showing the number of resources regarding the selected content, i.e., the number of pieces of content-related information, an area 92 for showing a period of time, and an area 93 for showing information regarding the second content item. In the resource displaying area 91, shown are the total number of resources regarding the current content, 1024, the number of font types, 568, the number of image types, 253, and the number of video types, 203. When the user selects the resource of image type in the resource displaying area 91, the media playback device 100 displays only the selected resource on the second content-related information display area 93. The time period displaying area 92 shows pieces of content-related information registered between the 23^{rd} of May and 17^{th} of August, 2011, in order from the most recent registration date. The user sees that the pieces of content-related information displayed on the screen have been registered 5 days ago, by referring to the area labeled by reference number 92a.

The media playback device 100 displays the content-related information 93a on the second content-related information display area 93 and also the most recent social media data 93b, associated with the content-related information 93a, on the area closet thereto. That is, the second content-related information display area 93 includes a content display area for showing at least one piece of content-related information associated with the selected content item, and a social media data display area for showing the most recent social media data.

The media playback device 100 determines whether a particular piece of content-related information is selected on the screen in step 709. If the media playback device 100 determines that a particular piece of content-related information is not selected on the screen in step 709, it proceeds with step 715 where it performs a user's requested function. For example, the media playback device 100 executes a navigation function according to a user's request and displays the content-related information that has not been displayed on the screen. Alternatively, the media playback device 100 performs the movement to the previous step or displays only one particular type of content-related information.

However, if the media playback device 100 determines that a particular piece of content-related information is selected on the screen in step 709, it displays detailed information regarding the selected content-related information on the detailed information display screen in step 711. The detailed information display screen displays the detailed information regarding the selected content-related information, and also social media data, associated with the content-related information, on an area close to the detailed information. That is, the detailed information display screen includes a detailed information display area for showing the detailed information regarding the selected content-related information and a social media data display area for showing social media data associated with the selected content-related information. To this end, the media playback device 100 requests the detailed information and the social media data associated with the content-related information from the mining server 200. For example, if the content-related information 94 is selected as shown in FIG. 9, the media playback device 100 displays the detailed information regarding the selected content-related information 94 and the social media data associated with the content-related information as shown in FIG. 1. That is, the media playback device 100 divides the screen into two areas and displays the detailed information regarding the content-related information on one area and the social media data on the other area. The other area is an area that allows for a scrolling operation.

The media playback device 100 then determines whether a signal is input to terminate the content-related information-providing mode in step 713. If the media playback device 100 determines that a signal is input to terminate the content-related information-providing mode in step 713, it terminates the mode and returns to a standby mode. However, if the media playback device 100 determines that a signal is not input to terminate the content-related information-providing mode in step 713, it proceeds with step 715 where it performs a user's requested function. For example, the media playback device 100 performs an operation for returning to the previous screen. The user selects social media data, reply to the selected social media data, or re-distribute (e.g., re-tweet on Twitter®) the selected social media data. To this end, when social media data is selected on the detailed information display screen, the media playback device 100 displays a menu window with a reply function and a redistribution function.

If the content-related information is a video, the media playback device 100 plays it back according to the user's request. If the user alters the country, the media playback device 100 requests the information regarding content related to the country from the mining server 200 and provides the received information. It should be understood that the mining servers are operated in respective countries.

As described above, the content-related information providing system and method according to the present invention can be implemented with program commands that can be executed on various types of computers and recorded on computer-readable recording media. The computer-readable recording media contain program commands, data files, data structures, or the like, or a combination thereof. The program commands recorded in the recording media may be designed or configured to comply with the invention or may be software. The computer-readable recoding media includes hardware systems for storing and conducting program commands. Examples of the hardware systems are magnetic media such as a hard disk, floppy disk, a magnetic tape, optical media such as CD-ROM and DVD, Magneto-Optical Media, such as floptical disk, ROM, RAM, flash memory, etc. The program commands include assembly language or machine code complied by a complier and a higher-level language interpreted by an interpreter. The hardware systems are implemented with at least one software module.

Although the embodiment is implemented in such a way that the media playback device 100 displays a content list, selects particular content, and acquires the content-related information in content-related information-providing mode, it should be understood that the present invention is not limited to the embodiment. For example, if a user requests content-related information while viewing a broadcast program, the media playback device 100 transmits the title of the broadcast program to the mining server 200 and receives, in real-time, the content-related information regarding the program therefrom.

The content-related information-providing unit 205 controls the provision of content-related information according to the features of the media playback device 100. For example, the content-related information-providing unit 205 filters videos or images, created in formats that cannot be played back via the media playback device 100, and then provides the content-related information to the media playback device 100.

Although the embodiment is implemented in such a way that the mining server 200 collects, analyzes and stores the content-related information, and also provides it to the media playback device 100, it should be understood that the invention is not limited to the embodiment. For example, the media playback device 100 collects, analyzes and stores the content-related information.

Although the embodiment is implemented such that selecting a content item switches the current screen to the content-related information list screen, it should be understood that the invention is not limited to the embodiment. For example, the embodiment may be modified such that selecting (or touching) a representative image for the content item switches the current screen to the content-related information list screen and selecting (or touching) a sub-image for the content item switches the current screen to a screen for showing the detailed information regarding the content.

As described above, the content related information providing system and method, according to the present invention, can collect information regarding content using social media data registered in a social media server, without using a portal website search function, and provides it to the user. Therefore, the system and method provides information regarding content to which recent user-oriented trend is reflected. Moreover, the user can easily view information regarding content that has been recently issued, without searching for additional portal websites.

While the present invention has been shown and described with reference to certain embodiments and drawings of the portable terminal, it will be understood by those skilled in the art that various changes in form and details may be made therein without departing from the spirit and scope of the invention as defined by the appended claims and their equivalents.

What is claimed is:

1. A method for providing content-related information, the method comprising:
creating a keyword related to the content;
collecting social media data including the created keyword;
analyzing the collected social media data, and extracting content-related information;
associating social media data with the extracted content-related information;
storing the content-related information; and
providing the stored content-related information.

2. The method of claim 1, wherein creating the keyword comprises:
creating the keyword by using information regarding a rank of the content provided by portal websites; and
adding additional information to the created keywords.

3. The method of claim 1, wherein collecting the social media data comprises:
removing improper social media data by applying a filtering process to the collected social media data.

4. The method of claim 1, wherein analyzing the collected social media data comprises:
extracting a Uniform Resource Locator (URL) included in the collected social media data; and
if the extracted URL is a shortened URL, restoring the shortened URL.

5. The method of claim 4, further comprising:
at least one of determining whether the restored URL is a previously analyzed URL, and
determining whether the restored URL is a spam URL.

6. The method of claim 4, wherein extracting information regarding the content comprises:
extracting web pages linked to the URL and texts, images and videos included in the web pages.

7. The method of claim 1, wherein storing the content-related information comprises:
displaying a content list of content items according to information regarding an order of preset ranks;
if one of the content items is selected in the list, displaying a piece of content-related information related to the selected content item; and
if the piece of content-related information is selected, displaying a detailed information regarding the selected content-related information.

8. The method of claim 7, wherein the selected content item comprises:
an image indicating corresponding content and a sub-image indicating the piece of content-related information related to the content.

9. The method of claim 7, wherein displaying of the piece of content-related information comprises:
selecting a type of content-related information; and
displaying the selected type of content-related information,
wherein the type of content-related information comprises at least one of texts, images and videos.

10. The method of claim 7, wherein displaying of at the piece of content-related information comprises:
displaying a most recent social media data, from among the social media data that are stored and associated with the content-related information, at a location close to the content-related information.

11. The method of claim 7, wherein displaying the detailed information comprises:
displaying the social media data, stored and associated with the selected content-related information, at a location close to the detailed information.

12. The method of claim 11, wherein displaying the detailed information comprises:
selecting the social media data displayed at the location close to the detailed information, and, if a redistribution signal is input, redistributing the selected social media data; and
if a reply to the selected social media data is input, transmitting the reply to a social media server where the selected social media data is registered.

13. A system for providing content-related information, the system comprising:
a content-related information-providing server for providing content-related information;
a social media service server for providing a social media service and storing social media data;
a mining server for creating a keyword related to the content, collecting and analyzing social media data including the keyword transmitted from the social media service server, extracting and storing information regarding the content, and providing the stored content-related information; and
a media playback device for receiving the content-related information from the mining server and displaying it.

14. The system of claim 13, wherein the mining server comprises:
a content-related information management unit for creating and managing the keyword;
a social media data-collecting unit for collecting at social media data including the keyword;
a resource-analyzing unit for extracting links included in the collected social media data, analyzing the extracted links, and extracting information regarding the content;
a database for storing the collected social media data associated with the extracted content-related information; and
a content-related information-providing unit for transmitting the stored content-related information to the media playback device.

15. The system of claim 14, wherein the content-related information management unit adds additional information to the created keyword.

16. The system of claim 14, wherein the social media data-collecting unit removes improper social media data by applying a filtering process to the collected social media data.

17. The system of claim 14, wherein the resource-analyzing unit extracts a Uniform Resource Location (URL) included in the collected social media data, and if the extracted URL is a shortened URL, restores the shortened URL.

18. The system of claim 17, wherein, if the restored URL is a previously analyzed URL or a spam URL, the resource-analyzing unit does not analyze resources.

19. The system of claim 14, wherein the resource-analyzing unit extracts web pages linked to the URL and texts, images and videos included in the web pages and stores the web pages linked to the URL and texts, images and videos included in the web pages in the database.

20. The system of claim 13, wherein the media playback device displays: a content list of content items according to information regarding an order of preset ranks; if one of the content items is selected in the list, a piece of content-related information related to the selected content item; and, if one of the pieces of content-related information is selected, detailed information regarding the selected content-related information.

21. The system of claim 20, wherein the content item comprises:
an image indicating corresponding content and a sub-image indicating a piece of content-related information related to the content.

22. The system of claim 20, wherein the media playback device displays particular type of content-related information according to the request, and
a type of content-related information comprises at least one of texts, images and videos.

23. The system of claim 20, wherein the media playback device displays, when a piece of content-related information is displayed, a most recent social media data, from among the social media data that are stored, associated with the content-related information, at a location close to the content-related information.

24. The system of claim 20, wherein when the detailed information is displayed, the media playback device displays, the social media data, stored and associated with the selected content-related information, at a location close to the detailed information.

25. The system of claim 24, wherein the media playback device transmits a request for redistributing at least one of social media data displayed at a location close to the detailed information, and registering a user's input reply, to the social media service server via the mining server.

26. A method for providing content-related information, the method comprising:
acquiring, by a media playback device, items of content and content-related information in a content-related information-providing mode;
configuring a content item including a content display area for identifying the content and a first content-related information display area for providing the content-related information, based on the acquired content and the content-related information; and
displaying a content list of content items.

27. The method of claim 26, wherein the content-related information is acquired via social media data including a keyword related to the content.

28. The method of claim 26, further comprising:
displaying a sorting reference for sorting the content items and a period of time for collecting the content-related information on the screen,
wherein the sorting reference and the period of time are set by a user's settings.

29. The method of claim 26, further comprising:
selecting a particular content item from the content list; and
displaying a content-related information list screen displaying content-related information related to the selected content item.

30. The method of claim 29, wherein the content-related information list screen comprises:
a resource display area for displaying a number of pieces of the content-related information related to the selected content item;
a time period display area for displaying the period of time for registering content-related information related to the selected content item and a registration date of the content-related information currently displayed on the screen; and
a second content-related information display area for displaying at content-related information related to the selected content item.

31. The method of claim 30, wherein the second content-related information display area displays a most recent social media data stored and associated with the content-related information.

32. The method of claim 30, wherein the resource display area displays a total number of pieces of content-related information and a number of pieces of content-related information corresponding to types of content-related information,
wherein the types of content-related information comprise at least one of texts, images and videos.

33. The method of claim 32, wherein displaying the content-related information list screen comprises:
selecting a type of content-related information; and
displaying the type of content-related information.

34. The method of claim 29, further comprising:
when one of the pieces of content-related information is selected, displaying a detailed information screen including detailed information regarding the selected content-related information.

35. The method of claim 34, wherein the detailed information screen comprises:
a detailed information display area for showing the detailed information regarding the selected content-related information, and a social media data display area for showing social media data stored and associated with the selected content-related information.

36. The method of claim 35, wherein the social media data display area is an area that allows scroll operations.

37. The method of claim 35, further comprising:
when one of the social media data displayed on the social media data display area is selected, displaying a menu window including a function for replying to or redistributing the selected social media data.
